(19) United States
(12) Patent Application Publication
(10) Pub. No.: US 2009/0000427 A1
(43) Pub. Date: Jan. 1, 2009

(54) Vehicle Door Opening Tool

(76) Inventor: Kath Pihlaja Lacina, Malbourne, FL (US)

Correspondence Address: JOEL I ROSENBLATT, 445 11TH AVENUE, INDIALANTIC, FL, 32903, US

(21) Appl. No.: 11/771,177

(22) Filed: Jun. 29, 2007

(51) Int. Cl. B25B 33/00

(52) U.S. Cl. 81/15.9

(57) ABSTRACT

A vehicle door opening tool used to unlock a vehicle door from outside the vehicle. It is made from a rod with an angle bend off center toward the handle. The handle is made with its plane perpendicular to a plane passing through the angle bend and the axis of the rod. A hock is formed at an end opposite the handle for use with the inside door latch to open the vehicle door.

### 1. FIELD OF THE INVENTION

This invention relates to a tool for opening a locked vehicle door and to the method of making the tool.

### 2. DESCRIPTION OF THE PRIOR ART

Tools for opening locked vehicle doors are well known and have been in use for a long time. They run the range from a simple bent coat hanger to highly specialized tools such as those formed for a specific vehicle type and model year. The most often experience is the use of a tools designed for insertion into the door of the vehicle and interface with the internal locking mechanism to unlock the door. While some hand tools are intended to be inserted into the vehicle door interior, others are intended to be used inside the vehicle to operate the door latch from the passenger's compartment, as would the passenger have.

### 3. SUMMARY OF THE INVENTION

A rod, most commonly with a circular, oval, elliptical, or polygon, cross section, used to open a locked door must be strong enough to be inserted in a narrow opening made between the vehicle door and the vehicle door jam and engage a locking mechanism and deliver sufficient force to unlock the door. Depending upon the type of locking mechanism, the force may be exerted left, right, up, or down, or in or out, relative to the vehicle door. This usually requires the rod to be of a material, such as steel, that can withstand such forces and to be of a sufficient thickness so as not to permanently deform in use. At the same time, the tool must be flexible to allow flexure of the tool and responsive movement of the operative tip of the tool about a radius sufficient to maneuver the tool in the enclosed and limited space of the vehicle interior.

Optimum use of the tool in the hands of a human operator, requires an ergonomic grip, that permits the operator to grip the tool and comfortably maneuver the tip toward and away from the door latch controls, exerting pushing or pulling forces, and to turn or rotate the operative tip, about the axis of the tool, as may be necessary to rotate the vehicle door latch.

At the opposite end from the handle, the tip of the tool may be shaped in a right angle bend forming a hook. To enhance the frictional grip of the tool on a door latch handle, and prevent the tool tip from slipping from the door latch or damaging the door latch when force is applied, a covering may be applied to the hook at the tool tip.

In a preferred embodiment, the invention is directed to a tool for use in unlocking a vehicle door. The tool is formed from a rod with an off center angle bend, a tip formed into a hooking mechanism a handle used to hold and manipulate the tool.

As shown for a preferred embodiment, the tool is a made from a unitary rod with a electrostatically applied coating, fixed by heat curing, as would be known to those skilled in the art.

As disclosed in a preferred embodiment, at a first end, the rod is bent or shaped into a handle with a space for hand insertion and gripping. At a second end opposite to the first end, the rod tip is bent or made in the shape of a hook. To achieve the best ergonomic positioning of the hook, the plane of the handle opening is made facing the hook at the tip second end of the tool and perpendicular to the plane passing through the angle bend, as described below, and the axis of the rod.

The rod is constructed with an angle bend at a distance displaced from its midpoint, as measured proximately from the handle at the first end to the tip at the second end and with the angle bend located between the angle bend and the handle at the first end.

What is disclosed is a hand tool for opening a locked vehicle from a position outside the vehicle, comprising, a rod including a first end and a second end; said rod including an axis and a midpoint on said axis and spaced proximately equally from said first end and said second end; said rod including an angle bend disposed on said axis between said midpoint and said first end and dividing said rod into a first part and a second part; d. said first end on said first part, including a handle and said second end on said second part including a tip.

Disclosed is the hand tool wherein, e. said handle includes an opening; f. said handle opening defining a plane lying substantially perpendicular to a plane intersecting said axis and said angle bend.

Disclosed is the hand tool, wherein, g. said tip includes a door latch tool, and wherein, h. said door latch tool is a hook; and wherein, h. said hook has a first part aligned with said axis and said hook has a second part extending from said axis at an angle to said axis.

Disclosed is the hand tool, wherein, j. said hook angle and said hook second part, is substantially in said plane intersecting said axis and said angle bend; including k. a hook cover; and l. said cover is mounted on said hook first part and said hook second part and extends to a point on said first part displaced from said hook angle.

Disclosed is the hand tool, wherein, m. said cover is frictionally engaged with said rod and said cover has a soft surface, relative to said rod surface. wherein,

said rod is wire rod approximately between 0.20 and 0.22; wherein said angle bend is substantially between 15 and 30 degrees; and wherein the ratio of the length of said first part to the length of said second part is between 3:4 to 1:3.

Disclosed is a method of making a hand tool for opening a locked vehicle from a position outside the vehicle, comprising the steps of, a. at a location displaced from a rod midpoint, making an angle bend, separating said rod into a first part and a second part and with said second part length longer relative to the length of said first part; b. at a first end of said first part opposite said angle bend, forming a handle with the plane of said handle perpendicular to a plane passing through said angle bend and the longitudinal axis of said first part and said second part.

Disclosed is the method of making a hand tool including the steps of c. at a second end of said second part, forming a hook in said rod; and the step of placing a cover over said hook; d. at a second end of said second part, forming a hook in said rod; e. forming a cover from an elastomer material; and f. inserting said hook into said cover to cover said hook and at least a part of said second part.

Disclosed is the method of making a hand tool including the step of coating said rod.

Disclosed is the method of making a hand tool wherein said step of separating said rod into a first part and a second part includes the step of separating into a first part with a length relative to said second part length by an ratio in a range of 1:3 to 3:4; wherein said step of making an angle bend includes the step of making said angle bend in a range between 15 degrees to 30 degrees; and wherein said step of making an angle bend includes the step of making said angle bend in a range between 15 degrees to 30 degrees.

These, and other features of the invention are described in the following and in Detailed Description of the Invention.

### BRIEF DESCRIPTION OF THE DRAWINGS

FIG. 1 is a perspective schematic view of the Vehicle Door Opening Tool.

FIG. 2 is a detailed schematic view of the tool tip at the end of the tool opposite to the handle.

### DETAILED DESCRIPTION OF THE INVENTION

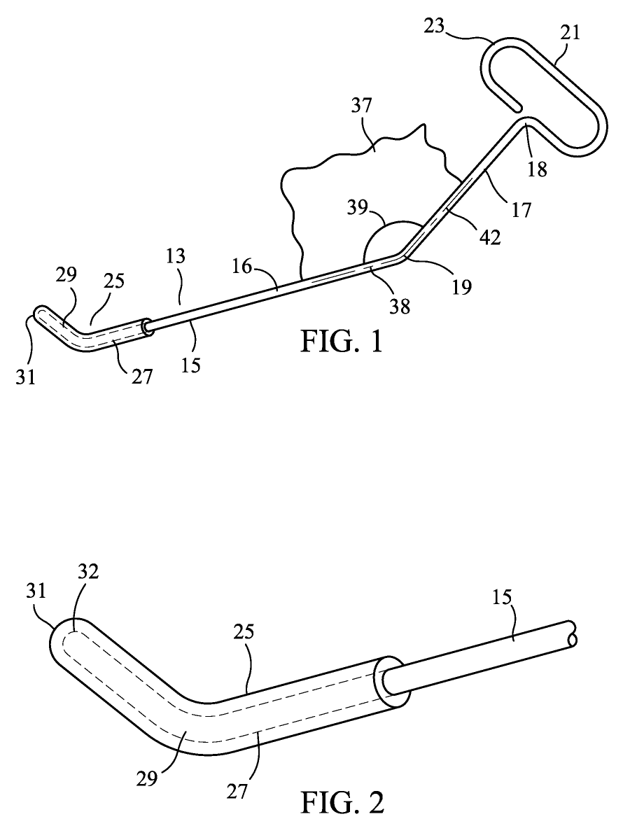

The vehicle door opening tool is shown generally in FIG. 1 by numeral 11. In a preferred embodiment, its body 13 is a metal wire rod stock between 0.210 and 0.220, as would be known by those skilled in the art, and substantially in a circular cross section, As would be apparent to those skilled in the art, the cross section of the tool 11 may be varied or it may be made from material other than a rod, without departing from the disclosed principles of the invention.

As shown in FIG. 1, the tool body 13 has a first part 17 and a second part 15, separated by an angle bend 19. A first longitudinal axis 38 is partially shown for the second part 15, terminating at angle bend 19. A second longitudinal axis 42 is partially shown for the first part 17, terminating at angle bend 19. The angle bend 19 is shown by arc 39 extending between longitudinal axis 38 on second part 15 and longitudinal axis 42 on first part 17. Opposite the angle bend 19, and at a first end 18, of the first part 17 of the tool body 13, a handle 21 is formed. The handle 21 is made with its plane 23 substantially perpendicular with a plane 37, intersecting the longitudinal axis 38, the angle bend 19 and the longitudinal axis 41 of the tool body 13. Arc 39 lies in the plane 37.

The angle bend 19, as shown for a preferred embodiment, is in a range of an included angel 39, as shown in FIG. 1, of 15 to 30 degrees. The location of the angle bend 19 along the length of the rod may vary from a point displaced from the rod 13 mid point 16 with the first part 17 shorter than said second part 15 by a ratio in a range from approximately 1:2 to about 3:4, and which may be varied about without departing from the disclosed inventive principles, as would be apparent to those skilled in the art. In a preferred embodiment, the ratio of first part 17 to second part 15, is approximately 2:3 and the angle bend is approximately 30 degrees.

Opposite the angle bend 19, at second end 25 of the second part 15, is tool tip 27. The tool tip is in the shape of a hook 29, shown in phantom inside too tip cover 31.

A detail of the hook 29 at the second end 25 of the tool 13, as shown in FIG. 2, with a partial view of second part 15. The hook 29 at the second end 25, is shown in phantom inside the tool tip cover 31. The material of the cover 31, may be an elastomer material, into which the tool tip end 32 may be inserted and the tool tip end slipped over the hook 29 to the full length of its internal cavity of the tool tip cover 31, as shown in FIG. 2.

The elastomer material of the tip cover 31, when stretched, exerts a counter force directed against the tool hook 29, holding it in place against any forces directed against it when the tool is in use and serves to hold the tip cover 31, in place. The elastomer material of the cover 31 is made softer or with a surface hardness less than the hardness of the rod, 13 preventing any damage caused to the door latch controls, by the harder surfaces of the rod material of the tool 13. At the same time, the relatively softer cover tip cover 31, provides a higher coefficient of friction, a larger surface area than the surface of area of the rod used to form the tool body 13, and relatively improved frictional contact with the door latch.

The vehicle door opening tool 13, in a preferred embodiment, may be bent into the desired shape as shown and described herein, and coated with an electrostatically applied coated which is cured in place, for example by heat treatment.

The positioning of the handle 21 shown with the plane 23 of the handle perpendicular to plane 37, permits a tool operator to grip the tool, with better control over the movement of the tip 27 and hook 29, in three axes of rotation. In use, as would be known to those skilled in the art a wedge or block may be inserted between the vehicle door frame and the door, preferably close to the top of the door and toward the side opposite the door hinge. In this way the greater flexibility of the door may be used to advantage. The hand tool is inserted tip down into the interior of the locked vehicle and proximate the door latch handles or controls, on the driver or passenger side.

An advantage of the invention as shown in a preferred embodiment, is the length of the radial arm formed in the hand tool between the tip 25 at the second end 25 of the tool 13 and the angle bend 19, relative to the radial arm formed in the hand tool between the angle bend 19 and the handle 23. As would be apparent to those skilled in the art, movement of the handle in a radial direction about a point proximate the angle bend 19, will be amplified by a larger movement of the tip 27 at the second end 25, proportionately, with respect to the ratio of the length of the first part and second part, as described above.

As would be apparent to those skilled in the art, the material of the tool body 13 and its cross section may be varied, without departing from the disclosed inventive principles. The coating of the tool body 13 may be varied, without departing from the disclosed inventive principles. The shape of the tip 27 may be varied, as may be useful for any configuration of door latch handles. The tip cover 31 may varied by varying the elastic quality or its length or the length of its internal cavity shown in phantom in FIG. 2, without departing from the disclosed inventive principles.

1-18. (canceled)

19. A hand tool for opening a locked vehicle from a position outside the vehicle, comprising,
a rod including a rod axis, a first end and a second end;
said rod including a midpoint on said axis;
said rod including an angle bend on said axis between said midpoint and said first end and dividing said rod into a first part including said first end and a second part including said second end;
said second end including a hook; and wherein said hook is substantially in a plane intersecting said angle bend, said first part and said second part, and said rod axis.

20. The hand tool of claim 19, wherein said first end includes a handle and said axis intersects said handle.

21. The hand tool of claim 20, wherein said plane intersects said handle.

22. The hand tool of claim 19, wherein said hook has a first part aligned with said axis and said hook has a second part extending from said axis at an angle formed between said hook second part and said axis and wherein said hook second part is substantially in said plane.

23. The hand tool of claim 22, wherein said first end includes a handle and said plane intersects said handle.

24. The hand tool of claim 22 wherein said first end includes a handle and said axis intersects said handle.

25. The hand tool of claim 19, wherein said angle bend is in range of approximately 15 to 30 degrees.

26. The hand tool of claim 19, wherein the ratio of the length of said first part to the length of said second part, is between 3:4 to 1:3.

27. The hand tool of claim 22, wherein said angle between said hook second part and said axis is substantially a right angle.

28. The hand tool of claim 22 including a cover for said hook extending over said angle between said hook second part and said axis.

29. A method of making a hand tool for opening a locked vehicle from a position outside the vehicle, comprising the steps of,
bending a rod, including a rod axis, a first end and a second end and a midpoint on said rod axis, between said midpoint and said first end, and forming an angle bend dividing said rod into a first part, including said first end and a second part, including said second end;
forming a hook is said second end substantially in a plane intersecting said angle bend, said first part and said second part, and said rod axis.

30. The method of claim 29, including the steps of forming a handle, in said first end, intersecting with said axis.

31. The method of claim hand tool of claim 29, including the step of forming a handle in said first end intersecting with said plane.

32. The method of claim 29, including the steps of forming said hook with a hook first part aligned with said axis and a hook second part extending from said axis at an angle between said hook second part and said axis and with said hook second part substantially in said plane.

33. The method of claim 29, wherein said step of bending said rod includes the steps of bending said rod in a range of approximately 15 to 30 degrees.

34. The method of claim 29, wherein the step of dividing said rod into a first part and a second part includes the step of dividing the relative lengths of said first part and said second part of a ratio in the range between 3:4 to 1:3.
